(19) United States
(12) Patent Application Publication
(10) Pub. No.: US 2008/0296974 A1
(43) Pub. Date: Dec. 4, 2008

(54) SNMP MANAGEMENT CARD CAPABLE OF SUPPLYING POWER TO NETWORK DEVICE ATTACHED THERETO

(75) Inventor: MING-CHIH HSIEH, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/869,755

(22) Filed: Oct. 10, 2007

(30) Foreign Application Priority Data
May 31, 2007 (CN) 200710200733.X

(51) Int. Cl. H02J 9/00; G06F 15/16

(52) U.S. Cl. 307/66; 709/250

(57) ABSTRACT

A simple network management protocol (SNMP) management card includes a processor, a network interface card (NIC) chip, a network port connected to the processor via the NIC chip, a power sourcing equipment (PSE) chip, and a power port connected to the network port via the PSE chip. The network port is configured to be connected to a network device. The PSE chip receives power from the power port and transmits the power to the network device via the network port.

### BACKGROUND

1. Field of the Invention

The present invention relates to simple network management protocol (SNMP) management cards, and particularly to an SNMP management card which can supply power to network devices attached thereto.

2. Description of Related Art

An SNMP management card is an intelligent interface that will allow an uninterrupted power supply (UPS) system to become its own intelligent network host. Thereby, the USP system can be controlled by a remote computer via the SNMP management card.

Referring to FIGS. 1 and 2, a block diagram of a conventional SNMP management card 10 and a block diagram of a conventional UPS system 30 having the conventional SNMP management card 10 and controlled by a computer 20 are shown. The SNMP management card 10 includes a processor 11, a transceiver 12, a network interface card (NIC) chip 13, an RS-232 port 14, a network port 15, and a power port 16 configured for connecting to a power supply connector (not shown) of the UPS system 30. The processor 11 is connected to the RS-232 port 14 via the transceiver 12, and connected to the network port 15 via the NIC chip 13. The UPS system 30 includes a power input port 31, a power output port 32, a storage battery 33 connected to the power input port 31 and power output port 32, and an SNMP management card interface (not shown). The storage battery 33 is charged by a power supply via the power input port 31 and supplies power to electrical devices via the power output port 32 when the power supply is cut off.

When the SNMP management card 10 is plugged into the SNMP management card interface of the UPS system 30, the SNMP management card 10 communicates with a processor (not shown) of the UPS system 30 via the RS-232 port 14. The computer 20 is connected to the network port 15 via a HUB 40. The computer 20 communicates with the processor 11 of the SNMP management card 10 via the NIC chip 13, and then the computer 20 can control the UPS system 30 via the SNMP management card 10.

However, when the power supply is cut off, the HUB 40 will be cut off from power, so that even if the remote computer 20 has power to work, the computer 20 cannot control the UPS system 30.

What is desired, therefore, is to provide an SNMP management card which can supply power to other network devices attached thereto such as HUBs.

### SUMMARY

An embodiment of a simple network management protocol (SNMP) management card includes a processor, a network interface card (NIC) chip, a network port connected to the processor via the NIC chip, a power sourcing equipment (PSE) chip, and a power port connected to the network port via the PSE chip. The network port is configured to be connected to a network device. The PSE chip receives power from the power port and transmits the power to the network device via the network port.

Other advantages and novel features of the present invention will become more apparent from the following detailed description of an embodiment when taken in conjunction with the accompanying drawings, in which:

### BRIEF DESCRIPTION OF THE DRAWINGS

FIG. 1 is a block diagram of a conventional SNMP management card;

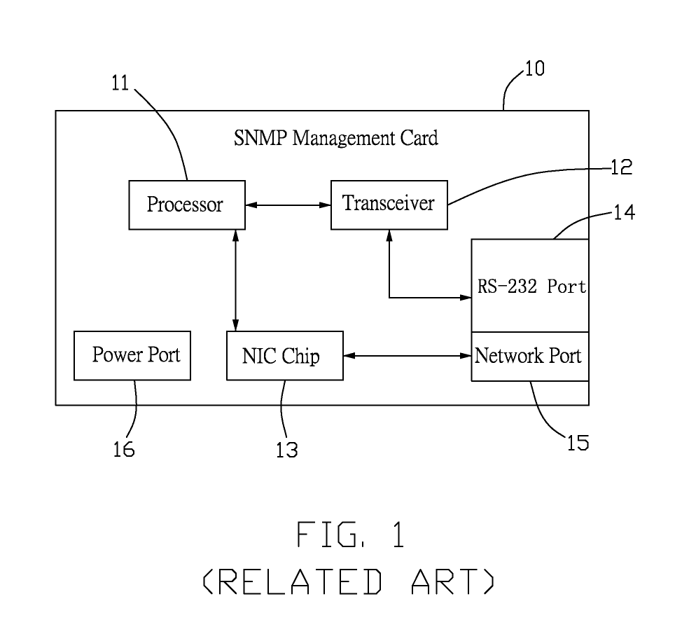

FIG. 2 is a block diagram of a conventional UPS system, together with a computer and a HUB;

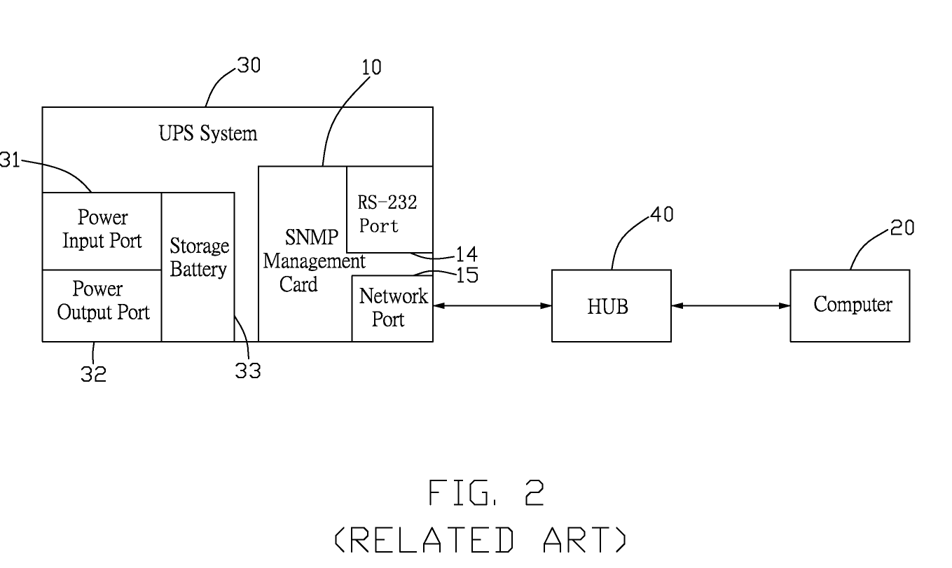

FIG. 3 is a block diagram of an SNMP management card in accordance with an embodiment of the present invention; and

FIG. 4 is a block diagram of a UPS system in accordance with the embodiment of the present invention, together with a computer and a HUB.

### DETAILED DESCRIPTION

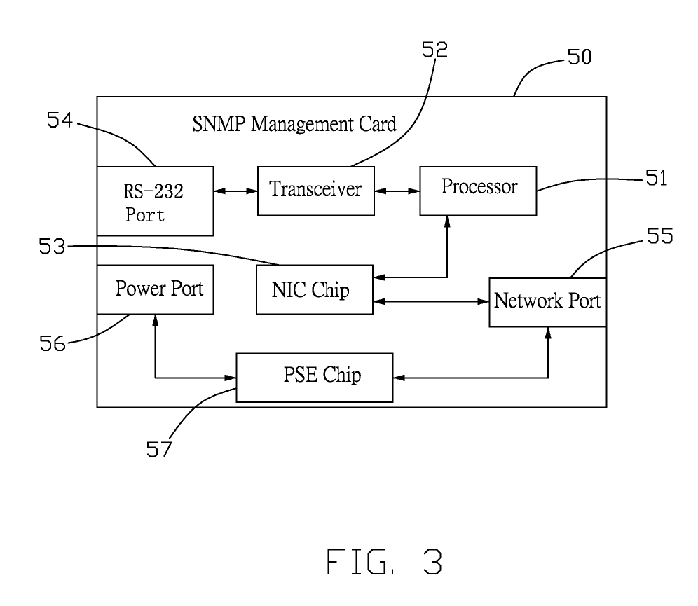

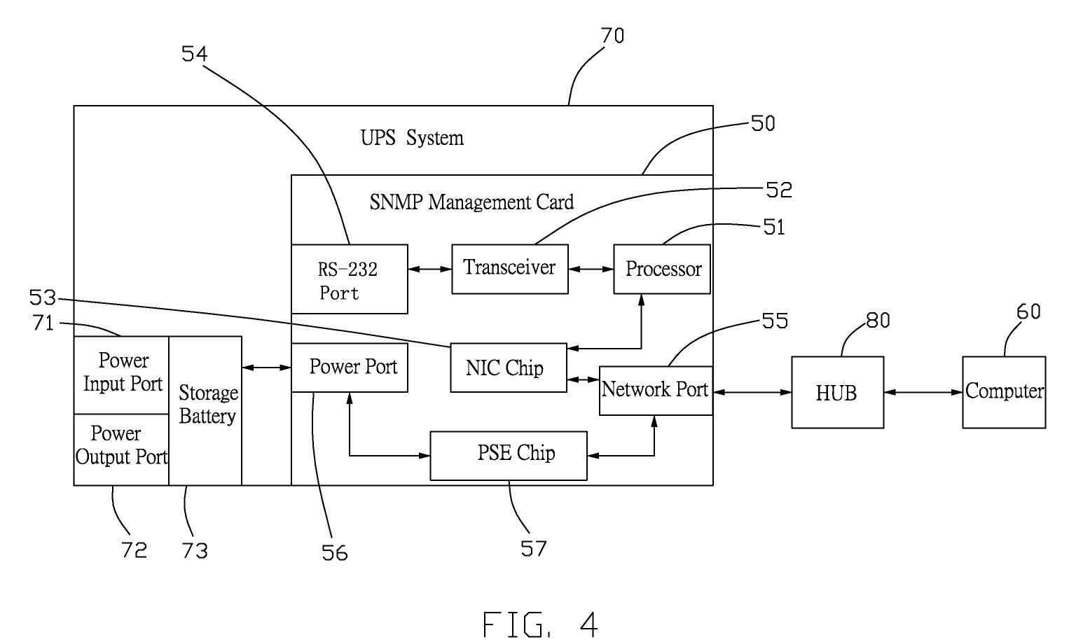

Referring to FIGS. 3 and 4, an SNMP management card 50 in accordance with an embodiment of the present invention is arranged in a UPS system 70, so that a remote computer 60 can control the UPS system 70. The SNMP management card 50 includes a processor 51, a transceiver 52, a network interface card (NIC) chip 53, an RS-232 port 54, a network port 55, a power port 56, and a power sourcing equipment (PSE) chip 57 based on Power over Ethernet (PoE) technology. The processor 51 is connected to the RS-232 port 54 via the transceiver 52 and connected to the network port 55 via the NIC chip 53. The power port 56 is configured for connecting to a power supply connector (not shown) and a storage battery 73 of the UPS system 70. The PSE chip 57 can receive electrical power from the power port 56, and transmit electrical power to powered devices (PDs), such as Ethernet HUBs, IP telephones, and webcams, over standard twisted-pair cables in an Ethernet network, via the network port 55 based on PoE technology.

The UPS system 70 includes a power input port 71, a power output port 72, and an SNMP management card interface (not shown). The power input port 71 and power output port 72 are connected to the storage battery 73. The storage battery 73 is charged by a power supply via the power input port 71.

When the SNMP management card 50 is plugged into the SNMP management card interface of the UPS system 70, the processor 51 of the SNMP management card 50 communicates with a processor (not shown) of the UPS system 70 via the RS-232 port 54. The computer 60 is connected to the network port 55 via a HUB 80 which is a PD (powered device) based on PoE technology. The computer 60 communicates with the processor 51 of the SNMP management card 50 via the NIC chip 53, and then the computer 60 can control the UPS system 70 via the SNMP management card 50.

When the power supply is cut off, the storage battery 73 supplies power to electrical devices via the power output port 72 and supplies power to the SNMP management card 50 via the power port 56. The PSE chip 57 receives electrical power from the power port 56, and transmits electrical power to the HUB 80 via the network port 55 based on PoE technology. Thereby, the HUB 80 can work continually, so that the computer 60 can control the UPS system 70 continually. Furthermore, the UPS system 70 also can supply other PDs in the Ethernet network via the network port 55 based on PoE technology.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A simple network management protocol (SNMP) management card comprising:
a processor;
a network interface card (NIC) chip;
a network port configured to connect to a network device, the network port connected to the processor via the NIC chip;
a power sourcing equipment (PSE) chip; and
a power port connected to the network port via the PSE chip, the PSE chip receiving power from the power port and transmitting the power to the network device via the network port.

2. An uninterrupted power supply (UPS) system comprising:
a storage battery; and
a simple network management protocol (SNMP) management card comprising a processor, a network interface card (NIC) chip, a network port configured to be connected to a network device and connected to the processor via the NIC chip, a power port, and a power sourcing equipment (PSE) chip, wherein the storage battery is connected to an input of the PSE chip via the power port, an output of the PSE chip is connected to the network port such that the PSE chip receives power of the storage battery from the power port and transmits the power to the network port, so as to supply the power to the network device.
